(19) United States
(12) Patent Application Publication
(10) Pub. No.: US 2009/0277891 A1
(43) Pub. Date: Nov. 12, 2009

(54) Pistol grip handle attachment for mig welding gun

(76) Inventor: Theodore A. Krupnicki, Webster, NY (US)

Correspondence Address: Fred L. Denson, Attorney, 14 East Main Street, PO Box 801, Webster, NY, 14580, US

(21) Appl. No.: 12/152,026

(22) Filed: May 12, 2008

(51) Int. Cl. B23K 9/32

(52) U.S. Cl. 219/137.31

(57) ABSTRACT

A welding gun attachment which converts a straight grip handle of a mig gun to a pistol grip handle. The pistol grip handle trigger is mechanically linked to the straight grip handle trigger so that movement of the pistol grip trigger causes corresponding movement of the straight grip trigger.

### BACKGROUND OF THE INVENTION

1. Field of the Invention

The present invention relates to welding gun handles and triggers.

2. Description of the Prior Art

The widely used mig welding gun has a handle for controlling the position of the gun in relation to the workpiece, and a trigger for controlling the gas flow to the head of the gun. While many types of grips are used with such handles, the most common types are the straight handle grip which is aligned in the general direction of the welding tube or wand, and the pistol grip handle which is aligned vertically (at an angle ranging from about 45 degrees to about 90 degrees) in relation to the wand. Individual preferences as well as the work performed dictate the type of grip used. In many cases, the weight and cumbersome nature of the hose make the use of a pistol grip handle preferable since it reduces or eliminates the need to position the hose over the user's shoulder thereby reducing user fatigue.

Several patents have recognized a variety of problems associated with various types of welding gun handles and have offered various solutions for these identified problems. For example, U.S. Pat. No. 7,342,199 by Zamuner describes an ergonomic attachment for use with guns having straight handle grips. The attachment facilitates the positioning of the user's hand and fingers on the gun to reduce user fatigue. A related U.S. Pat. No. 6,610,963 by Zamuner uses an ergonomic handle attachment that allows the welder to manipulate a straight handle grip without the need to exert a consistently tight gripping force on the gun. U.S. Pat. No. 6,815,641 by Doherty discloses a straight grip handle with a trigger that can be moved to various locations on the handle for user convenience.

Notwithstanding the advantages associated with the foregoing patents, there is no suggestion for converting a gun having a straight handle grip to one having a pistol handle grip to achieve the ergonomic advantages associated with each handle. Thus, it is necessary to use two separate guns to achieve these advantages.

It is therefore an object of this invention to provide a device for converting a straight grip handle mig gun to a pistol grip handle mig gun.

It is another object of this invention to provide a pistol grip handle that is easily attachable and detachable to and from a straight grip handle mig gun.

It is a further object of this invention to provide an attachable pistol grip handle for a mig gun that is readily transportable because of its dimensions and weight.

It is still another object of this invention to provide an attachable pistol grip handle having improved ergonomics in relation to a conventional straight grip handle for mig welding guns.

### SUMMARY OF THE INVENTION

These and other objects are accomplished by use of a pistol grip handle attachment with a straight handle mig welding gun. The attachment includes a pistol grip handle assembly and a mounting means for attaching the handle assembly to the mig gun handle. The handle assembly includes a pistol grip handle that has two opposing walls, each wall comprising half of the handle. When joined together, the walls form an internal cavity that houses a trigger assembly. The trigger assembly includes a pivotally mounted trigger having one end of a tang attache thereto. The distal end of the tang contains a set screw that is adjusted to contact the trigger of the straight handle mig gun. The mounting means includes a pair of brackets which are attached to the pistol grip handle assembly and which are attachable to a mig gun having a straight handle. When the pistol grip handle assembly is attached to the straight handle mig gun, depression of the pistol grip trigger causes movement of the tang and adjustable set screw. Because the set screw is adjusted to contact the mig gun trigger, movement of the screw causes a corresponding depression of the mig gun trigger. When the depressing force against the pistol grip trigger is released, the trigger is returned to its original at-rest position because of the restoring spring action force from the mig gun trigger.

The pistol grip handle attachment of this invention is easily attachable to a straight handle mig gun by the insertion of two bolts. It is cost effective because it eliminates the need for two separate welding guns, one with a straight handle and one with a pistol grip handle. It also enhances user safety by reducing muscle strain and/or fatigue, particularly when using a straight handle gun is used on work that is more accessible with a pistol grip handle than a straight handle. The inventive device described herein is also readily transportable and easy to use. The device can be attached in a matter of seconds. Also, since it weighs less than 8 ounces and is only 7 or 8 inches in length, it can easily be attached to a work utility belt without hampering the wearer's work performance.

### BRIEF DESCRIPTION OF THE DRAWINGS

FIG. 1 is an isometric view of the welding gun pistol grip handle attachment of this invention.

FIG. 2 is an isometric section view taken along 2-2 of FIG. 1.

FIG. 3 is an isometric view of a mig welding gun with a straight handle grip.

FIG. 4 is an isometric view of the welding gun shown in FIG. 3 with the pistol grip handle attachment shown in FIG. 1.

FIG. 5 is a partial isometric view of the welding gun and pistol grip handle attachment shown in FIG. 4.

### DETAILED DESCRIPTION OF PREFERRED EMBODIMENTS

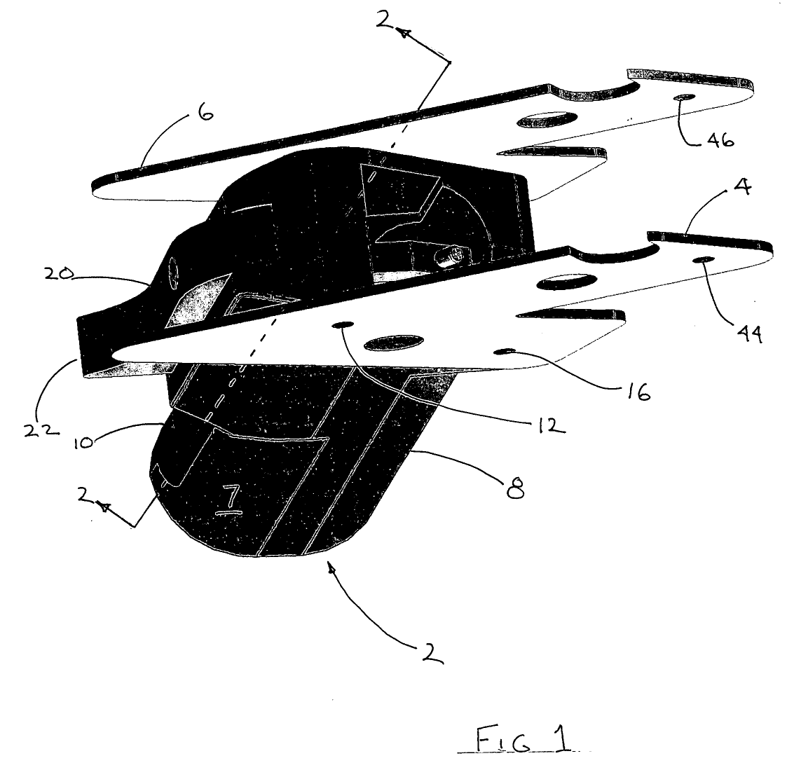

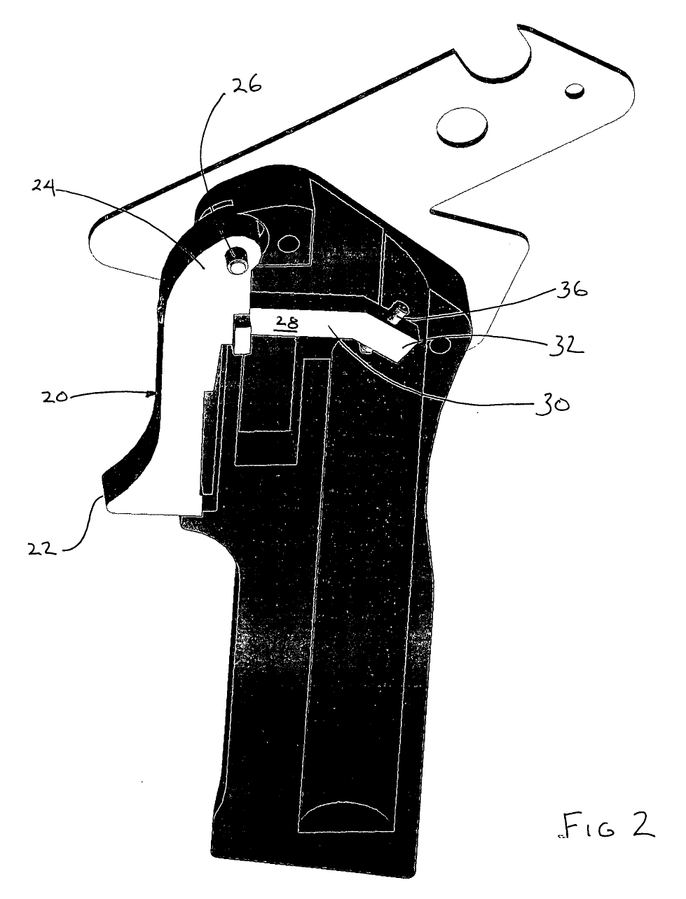

As shown in FIGS. 1 and 2, the pistol grip handle attachment includes handle assembly 2, first mounting bracket 4 and second mounting bracket 6. Pistol grip handle 7 of handle assembly 2 includes first wall 8 and opposing second wall 10. Each wall is shaped so as to form half of handle 7 and are joined by bolts that pass through bolt holes positioned in each wall. Pistol trigger 20 is sandwiched between walls 8 and 10 in a manner such that its first or proximal end 22 extends through an opening in handle 7 while its second or distal end 24 is positioned within the housing of handle 7. Trigger 20 is pivotally mounted on pivot pin 26 that passes through an opening in distal end 24 and is anchored by corresponding recesses in walls 8 and 10. Tang 28 has a first or proximal end 30 that is affixed to second or distal end 24 of trigger 20. The remaining or distal end 32 of tang 28 contains a threaded opening with adjusting screw 36 positioned therein. The positioning of trigger 20, tang 28 and adjusting screw 36 are such that movement of trigger 20 causes movement of adjusting screw 36.

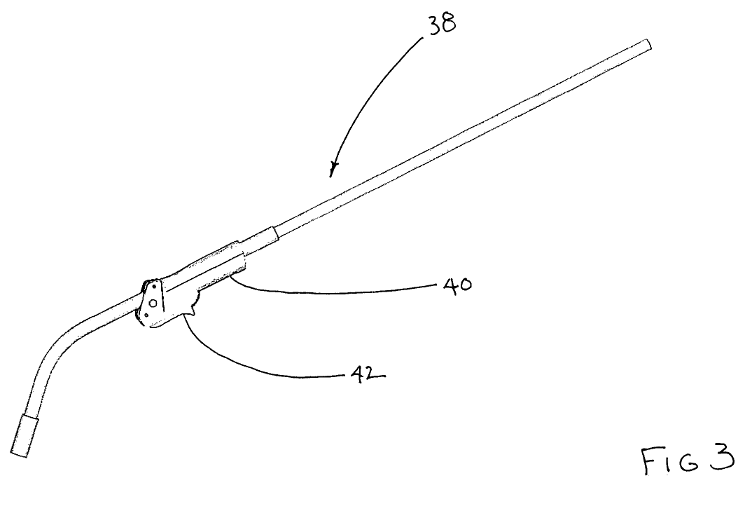

Mounting brackets 4 and 6 are used to attach the pistol grip handle attachment shown in FIG. 1 to a mig gun 38 that has a straight handle 40 and trigger 42 as shown in FIG. 3. Mounting brackets 4 and 6 are secured to walls 8 and 10 of pistol grip handle 7 by bolts and corresponding bolt holes 12 and 16 in the brackets and walls. The mounting brackets contain a second set of bolts and bolt holes 44 and 46 for securing the pistol grip handle attachment to mig gun 38.

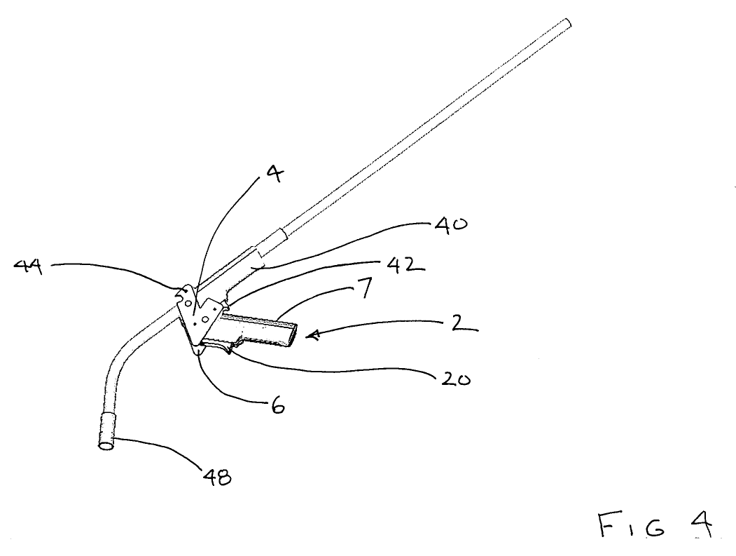

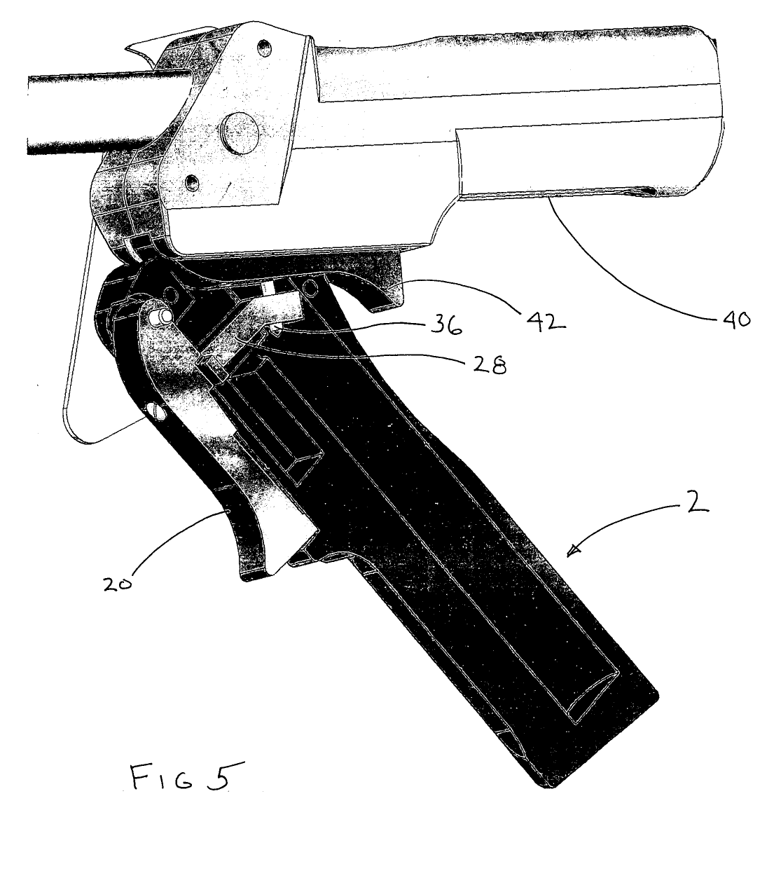

As shown is FIGS. 4 and 5, pistol grip handle assembly 2 is attached to straight handle grip 40 in a manner such that adjusting screw 36 contacts mig gun trigger 42 in its at rest position. When screw 36 is appropriately adjusted, depression of the pistol grip handle trigger 20 causes a corresponding depression of straight handle trigger 42. When the depression force against trigger 20 is released, trigger 20 is returned to its at-rest position by the counter force of a trigger spring (not shown) for trigger 42.

The invention has been described in detail with particular reference to certain preferred embodiments thereof, but it will be understood that variations and modifications can be effected within the spirit and scope of the invention. In this regard, various means for attaching the pistol grip handle assembly to a mig gun can be used in place of the bracket mounting means described herein. Also, the attachment of this invention can be used with a variety of welding guns that have straight handle grips that vary from the grips described herein.

What is claimed is:

1. A pistol grip handle attachment for use with a straight handle mig gun and trigger, said attachment comprising:
a. a pistol handle assembly having
(i) a pistol handle; and
(ii) a pistol trigger which is mechanically linked to said straight handle mig gun trigger; and
b. mounting means for attaching the handle assembly to the mig gun handle in a manner such that movement of said pistol trigger causes movement of said straight handle mig gun trigger.

2. The pistol grip handle attachment of claim 1 wherein the mounting me for attaching the handle assembly to a mig gun handle comprises a mounting bracket attached to said pistol handle.

3. A pistol grip handle attachment for use with a straight handle gun and trigger, said attachment comprising:
a. a handle assembly having
(i) a first wall, an opposing second wall, and fastening means connecting said first and second walls;
(ii) a pistol trigger having a first or free end and a second or distal end, said trigger being pivotally mounted on a pin positioned between said first and second walls;
(iii) a tang having a first end attached to the distal end of said trigger, and a second or distal end having an opening therethrough;
(iv) an adjusting set screw positioned in the opening of said tang; and
b. mounting means for attaching the handle assembly to the mig gun handle in a manner such that movement of said pistol trigger causes movement of said tang and a corresponding movement of the head of said set screw against the mig gun trigger.

4. The pistol grip handle attachment of claim 3 wherein the mounting means for attaching the handle assembly to a mig gun handle comprises a first mounting bracket attached to said first wall and a second mounting bracket attached to said second wall, said first and second mounting brackets having fastening means for attaching the mounting brackets to the mig gun handle.
